(19) United States
(12) Patent Application Publication
(10) Pub. No.: US 2010/0180593 A1
(43) Pub. Date: Jul. 22, 2010

(54) System for Closed-Loop Large Scale Geothermal Energy Harvesting

(75) Inventors: Richard Schaller, Niceville, FL (US); Ali Eihusseini, Orlando, FL (US)

Correspondence Address: Richard Schaller, 101 Dana Pointe, Niceville, FL, 32578, US

(73) Assignee: Environmental Power Associates, Inc., Niceville, FL (US)

(21) Appl. No.: 12/245,809

(22) Filed: Jan. 21, 2009

(51) Int. Cl. F03G 7/00

(52) U.S. Cl. 60/641.2

(57) ABSTRACT

This invention applies technologies and processes to effectively harvest geothermal energy on a large scale defined as electrical power production 100 kilowatts and above. This invention uses Seebeck materials hosted in an infrastructure of electrically inert and near thermally and chemically inert polymers and resins to survive in the very hot and chemically active deep well environments while producing large amounts of electrical power. The Seebeck materials are subjected to geothermal heat energy in the range of 0 to 500 degrees Celsius in the deep well which can be a pre-existing man-made or naturally existing hole or one drilled specifically for this purpose. The Seebeck materials convert the geothermal energy directly to electrical power which is transmitted to the surface through a wire array imbedded in our invention. This invention is closed loop below the surface and only interacts with the radiated subterranean geothermal energy (i.e., heat) and is, therefore, of absolute minimum environmental impact to the local geology. Seebeck materials can be metal, crystal, or liquid. Electric current is generated within the Seebeck materials through a temperature gradient which moves electrons resulting in substantial current. The hot-side is the outer structure of the device in the deep well. Electric current is initiated, maintained, and regulated by circulating a “cold”-side fluid (e.g., liquid or gas) down an inner pipe which returns to the surface on the cold side of the Seebeck material and carries exhaust heat to create the hot side for other Seebeck material arrays closer to the surface or to a cooling mechanism at the surface for re-circulation into the deep well.

### BACKGROUND

We provide this information as further background in the development of our invention. The US General Accounting Office (GAO) has documented over two million abandoned deep oil and gas wells throughout the United States. These abandoned wells represent access portals to Earth's limitless reservoir of geothermal energy. Even regions with moderate geological conditions have an abundance of abandoned oil and gas wells. For instance, Florida, with its relatively low thermal potential when compared to many of the Rocky Mountain States, has over two thousand abandoned oil wells some to a depth of 18,000 feet. By installing our invention these abandoned wells can be converted economically to electrical power production with the added benefit of making them environmentally safe sources of revenue.

Our invention is based upon the fact that absolute temperature increases with depth at a predictable rate. One hundred years of oil well drilling experience (documented by official US Geological Survey Well Logs) has resulted in an abundance of data that clearly shows that temperature increases uniformly with depth. In fact, below 300 feet the temperature increases one degree Fahrenheit for each sixty feet of depth (or 1 degree Celsius for every 30 meters depth) and even though this temperature rule can vary based upon local geology, it is a reliable measure of worldwide geological thermo-dynamics. We engineered our invention to take advantage of all geological conditions regardless of absolute temperature.

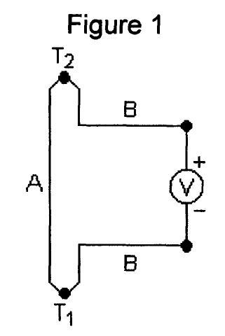

Our invention is based upon the Seebeck effect. The Seebeck effect is heat absorption by two dissimilar metals at different rates creating current near their junction. When the temperature across the junction is stabilized then current ceases. However, establishing a heat sink forms a continuous temperature gradient which causes current to flow as long as the gradient exists. The electric current generated in this manner is direct current (DC) and must be transformed into alternating current (AC) for use in most applications. The conversion efficiency is a function of temperature differential between the heat source (in this case geothermal energy) and the heat sink (in this case a circulating fluid or gas). The efficiency is also based upon the Seebeck coefficient of the material. Metals, crystals, and fluids all display Seebeck properties with significant variations in efficiency. Seebeck materials like bismuth and cadmium telluride have shown efficiencies near 5% and some semiconductors have demonstrated over 15% efficiency at temperature differentials of 200 degrees Celsius. FIG. 1 is a schematic of the Seebeck Effect where “A” is the Seebeck coefficient material, “T₁” and “T₂” represent the temperature differential or gradient, “B” represents charge carriers, and “V” is the resulting voltage.

The Seebeck effect is commonly associated with thermocouples. Several thermocouples when connected in series are a thermopile, which increases the output voltage. These characteristics of the Seebeck effect enable our closed-loop method. But regardless of the Seebeck material, only advanced materials like silicon carbide can withstand the harsh conditions in the deep well. That is why our invention includes advanced near electrically, thermally and chemically inert polymers and resins to form the superstructure to host the Seebeck materials without impacting their efficiency.

Our invention is based upon polyetheretherketone (PEEK) and/or self-reinforced polyphenylene (SRP) materials to form the superstructure for the device. These materials are man-made polymers and resins currently in use on a small scale in the deep well environment to protect wire bundles and sensors. Our invention is the first large scale use of these materials in deep wells. Our invention uses these materials as the body of the cylinders that host the Seebeck materials adding strength and protecting the inside of the structure from toxic chemicals. Thermally and electrically active materials are unacceptable for this invention because they absorb radiated geothermal energy away from the Seebeck materials reducing their efficiency. The projected life-expectancy for PEEK and SRP in the deep well environment is over thirty years making them excellent candidates for this application.

### DETAILED DESCRIPTION OF THE INVENTION

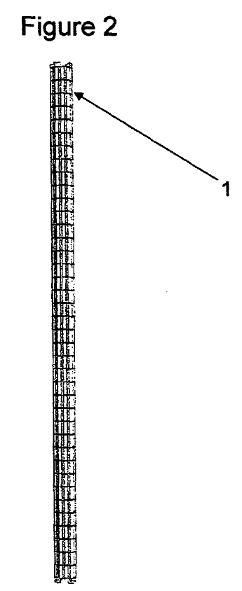

This invention is depicted in FIG. 2. It is a pipe-within-a-pipe cylinder with arrays of Seebeck materials as most of its outer surface (1). The cylinder frame is composed of PEEK or SRP material and forms the electrically inert and near thermally and chemically inert structure to house arrays of Seebeck materials that can be one, two, or three layers in serial depth. This cylinder structure includes an inner pipe to transport coolant gas or liquids to the lowest point in the structure and then released into the outer chambers. The outer chambers are configured to return exhaust to the surface for heat removal and recycling into the deep well. The closed-loop circulation of coolant gas or fluid provides the cold side of the stable temperature gradient necessary to cause current to flow with the radiated geothermal heat from the environment creating the hot side of this thermocouple. It is this stable temperature difference that creates the continuous electrical power transmitted to the well-head for transformation to alternating current and distribution through the local power grid. The cylinder is modular to work in conjunction with a series of cylinders lowered one on top of the other into a deep well. The cylinder depicted in FIG. 2 is one embodiment scaled to a radius of 5.1 inches and ten feet in length. In this embodiment the cylinder surface includes 480 twenty-watt Seebeck material plates for a total power generation potential of 9,600 watts at 200 degrees Celsius temperature differential. However, the radius, length, and layers of Seebeck materials can be tuned to the geometry and temperature of the deep well. We refer to this embodiment as the “disco” cylinder due to its resemblance to the mirrored balls popular in dance hall discotheques.

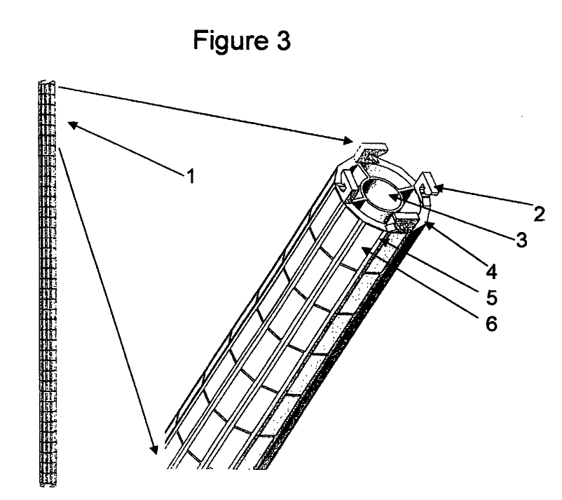

FIG. 3 is an expanded view of the cylinder to better display the locking mechanism between cylinders (2), the annulus that can be used to transport the coolant fluid or gas to the bottom of the structure (3), the PEEK or SRP super structure (4,5), and the Seebeck material plates (6) that harvest the geothermal energy and convert it to electrical power.

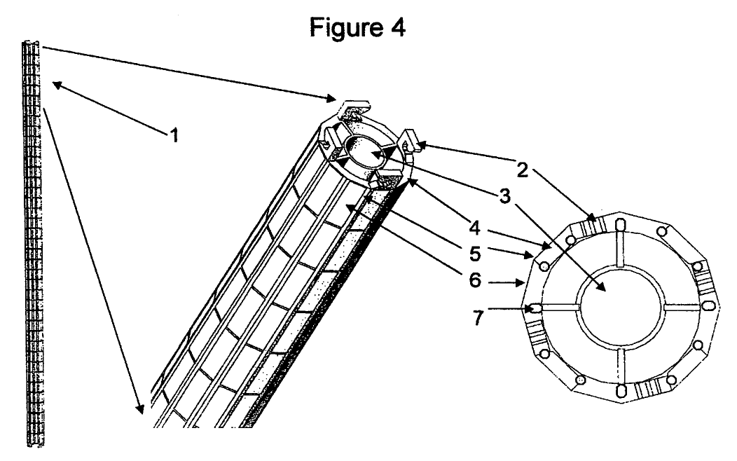

FIG. 4 is a further expanded view to depict one method of hosting the copper or aluminum wires (7) which will be imbedded in the PEEK or SRP superstructure to transport electrical power to the surface.

The following steps identify the high-level tasks required to install this close-loop system.
1. Records search to identify suitable deep wells.
2. Clear obstructions from the borehole.
3. Construct tower over well head to install disco cylinders.
4. Seal well-bottom.
5. Pour thermal fluid (e.g., oil) into borehole.
6. Install disco cylinders.
7. Connect wire leads from the well head to switches and transformers and then meter to the local grid.
8. Begin metered flow of cold-side fluid (e.g., water, liquid nitrogen, iso-butane, or lithium bromide, etc.) into the center pipe to begin current flow.

The cylindrical format is significant because it conforms to the geometry of the deep well while creating the best aspect for exposing the solid state array to the radiated heat in the well.

The borehole diameter at the bottom of a 6,000 meter deep well is nominally six inches, we have designed one embodiment with a 5.1 inch outer diameter and a two-inch diameter center pipe. A typical cylinder can vary in length but would maintain the same cylindrical configuration to make it compatible with the borehole geometry and casing.

Each cylinder is an independent module that would be fastened to the top of its predecessor and lowered together to be stacked in the hole using the same techniques as lowering steel casing into the bore hole.

The disco cylinders are stacked in the borehole with stabilizers, connectors, and wire bundles. Using sensors, switches and a metering system to monitor system performance to electrically bypass any cylinder that may be malfunctioning to prevent a single point of failure within the system.

Our invention includes sealing the bottom of the deep well prior to installing the disco cylinders to minimize toxic emulsions from interfacing with the cylinder arrays.

Our invention uses a heat transfer fluid to facilitate efficient heat transfer from the casing to the cylinder arrays. In this case we anticipate using a low-sulfur crude oil as the heat transfer fluid. The purpose of this heat transfer fluid is to facilitate heat transfer from the well casing to the hot side of the Seebeck material. An air gap would allow much of the heat to escape the well without radiating efficiently to the Seebeck material. This heat transfer fluid also serves as a buoyant medium that supports the cylinder tower serving as a cushioning mechanism in the event of tremors. Another layer of protection from the environment is the deep well's steel casing that lines the length of the well.

Our invention includes a chemical layer of protection that promotes high thermal absorption while sealing the Seebeck materials from exposure to the harsh toxicity of the deep well environment. We coat the exposed surfaces with a layer of acid-resistant epoxy. This commercially-available epoxy effectively seals and protects the hot-side of the Seebeck material from oil, gasoline, acids, caustics, and most solvents.

Each cylinder module is also configured with raised rails (edges) to prevent the Seebeck modules from scraping the inner well casing during lowering into the bore hole. When stacking the cylinders in the deep well weight becomes an issue. A ten-foot length cylinder of 5.1 inch radius will weigh approximately 120 pounds. A tower of 520 cylinders stacked vertically would subject the bottom cylinder to the weight of the entire tower which is 62,400 pounds. The PEEK or SRP superstructure has a compressive strength of over 34,000 pounds per square inch with eight square inches of connector surface between cylinders. Therefore, the 62,400 pound weight of the cylinder tower is well within the compressive strength of the bottom cylinder which is in excess of 272,000 pounds. Tailoring the modular cylinders so that the PEEK or SRP cylinder edges compress against the borehole casing would dissipate much of the weight laterally to the steel casing with the remaining vertical weight serving to effectively seal the contact between cylinders.

This invention can be adapted to fit any borehole geometry. We pack cylinders into the borehole with connectors joining them electrically and gravity will compact them vertically and maintain seal integrity between modules.

A significant technical issue is retrieving the electricity from the bottom of a deep well possibly 20,000 feet/6,096 meter in depth without transmission loss. To illustrate this issue and our solution we discuss here a five megawatt embodiment which would consist of 520 cylinders stacked one on top of the other. Each one of these disco cylinders would require 480 each 20-watt solid state electronic devices connected in series producing 9,600 watts with a capacity of 1 amp or 9,600 volts. The disco cylinders would be configured in serial groups of 10 disco cylinders in each group. In this embodiment each cylinder group would produce 96,000 Volts at 1 amp yielding 96 kilowatts. A separate pair of wires is connected to each bank of tubes and brought to the top of the 520 tube stack where they are connected in parallel. This configuration provides a capacity of 96,000 volts at 50 Amps at the well head for a continuous power generation of nearly 5 megawatts.

Our invention initiates and regulates electrical current by circulating a coolant gas or liquid down the center pipe. This coolant is protected from the environment during its descent by the center pipe structure of the cylinder and is evenly pressure ported through a geometry of openings in each cylinder where it is exposed to the cold side of the Seebeck materials, absorbs heat, and rises through the outer chambers of the cylinder to the surface carrying residual heat to the surface or ported to the hot side of the Seebeck materials. This residual heat is removed through a Rankine or Stirling cycle and returned to the center pipe of the deep well. Candidate compounds to remove heat from the deep well are water, liquid nitrogen, isobutene, and a lithium bromide solution. This invention is not limited to these compounds and could include a gas or liquid developed exclusively for this purpose.

1. The System for Closed-Loop Large Scale Geothermal Energy Harvesting is a means for harvesting geothermal heat energy and converting it to electrical power on a large scale (over 100 kilowatts) using Seebeck effect materials as thermoelectric generators imbedded together with power transmission wiring in electrically inert and near thermally and chemically inert polymer and resin cylinders. These cylinders are inserted into geothermal environments where they are exposed to continuous geothermal heat radiation effectively harvesting that geothermal energy for conversion to electrical power. By injecting and circulating a gas or fluid closed-loop inside the cylinder causes a stable temperature gradient across the Seebeck effect material creating electric current which is carried to the surface of the geothermal environment by the transmission wiring in the cylinder.
